(19) United States
(12) Patent Application Publication
(10) Pub. No.: US 2015/0324752 A1
(43) Pub. Date: Nov. 12, 2015

(54) COMBINE LOCAL OFFERS, SOCIAL NETWORK, AND CALENDAR TO PROVIDE PERSONALIZED EXPERIENCE FOR CONSUMERS

(71) Applicant: Google Inc., (US)

(72) Inventor: Lei Chen, Santa Monica, CA (US)

(73) Assignee: Google Inc., Mountain View, CA (US)

(21) Appl. No.: 13/796,887

(22) Filed: Mar. 12, 2013

(51) Int. Cl. G06Q 10/10

(52) U.S. Cl. CPC G06Q 10/1095

(57) ABSTRACT

Method and apparatus and for combining local offers, social network and calendar to provide a user with personalized content items, such as advertisements (ads). In accordance with some embodiments, a computer implemented method generally includes a preference for an event type is determined for each of a plurality of social network users. A personalized ad associated with the preference is generated. The personalized ad includes a local offer from a business. A suggestion calendar is populated with the personalized ad. The suggestion calendar is accessible to each of the plurality of social network users.

### BACKGROUND

Consumers can have difficulty finding dates and times for group activities with family and friends. Consumers, and their family and friends, may use various network accessible devices (e.g., smart phones, tablets, laptops, e-readers, etc.).

Social networks, such as Google+, Facebook, LinkedIn, may provide a forum for consumers to interact with family and friends to share common interests and activities, such as restaurant dining, sporting events, ethnic-related activities, etc. Social networks may be accessible through the network accessible devices.

A business owner may want to make local offers to consumers. The business owner can be an advertisement provider (advertiser) that generally provides advertisements for display on the network accessible devices. The advertisements (advertisement items) can take a variety of forms, such as web pages, mobile applications (apps), audio works (e.g., mp3 files), video works, textual works (e.g., e-books), etc.

There is no optimal solution for consumers to organize group activities around the local offers. Advertisement items, i.e. local offers, personalized to the interests and activities of the consumer may be more valuable to the consumer and the advertiser by providing local offers by the advertiser to the consumer that are more likely to be accepted.

### SUMMARY

Various embodiments disclosed herein are generally directed to an apparatus and method for a combination of local offers, social network, and calendar that may provide a personalized ad experience for consumers.

In accordance with some embodiments, a computer implemented method generally includes a preference for an event type is determined for each of a plurality of social network users. A personalized ad associated with the preference is generated. The personalized ad includes a local offer from a business. A suggestion calendar is populated with the personalized ad. The suggestion calendar is accessible to each of the plurality of social network users.

These and other features and advantages which may characterize various embodiments can be understood in view of the following detailed discussion and the accompanying drawings.

### BRIEF DESCRIPTION OF THE DRAWINGS

FIG. 1 provides a functional block representation of a network-based system in accordance with various embodiments.

FIG. 2 provides another functional block representation of the network-based system in accordance with various embodiments.

FIG. 3 illustrates an example manner in which an ad content item can be requested using the system of FIGS. 1-2.

FIG. 4 illustrates selection (clicking) of a content item and its relationship to an associated landing page.

FIG. 5 is a representation of a calendar web page in accordance with various embodiments.

FIG. 6 represents an order content in accordance with various embodiments.

FIG. 7 is a flow chart for a LOCAL OFFER PROCESSING routine generally illustrative of steps carried out in accordance with some embodiments.

### DETAILED DESCRIPTION

The present disclosure generally relates to combination of local offers, social network, and calendar that may provide a personalized experience for consumers.

When a user of a network accessible device requests information, a content item, such as an advertisement item from an advertiser can be transferred to the device for presentation via a graphical user interface (GUI) of the device. The advertisement item may take a variety of forms, such as but not limited to a web page, a mobile app, an e-reader book, an email service, a search engine, a game, an audio work, a video work, etc.

In some cases, the advertisement item can include a creative portion and an interactive portion. The creative portion may provide textual, audio, image and/or video information to the user. The interactive portion, when selected (“clicked”) by the user, connects the device to a linked web page or other location (“landing page”) associated with the creative portion.

In an effort to improve user response to advertisement items and thereby turn the user into a consumer of the advertisement items, the advertisement providers often endeavor to select advertisement items personalized to interests and activities of the user. The advertiser for a particular product or service, for example, may wish to have its advertisement items displayed on the network accessible devices of users involved in interests and activities that cover topics relevant to the product/service offered by the advertiser. Social networks may provide an opportunity determine the interests and activities of users. Where the user consents to use of such data regarding the user's interests and activities, the data may be used to provide personalized ads to the user through a combination of local offers, social network, and calendar events responsive to the user's interests and activities.

Free time to participate in interests and activities presents a challenge to users and their family and friends. There is no optimal solution for users to organize group activities around the local offers from advertisers. By providing events on a suggestion calendar with local offers that may match the interests, activities, and free time of the user, the advertiser may achieve a higher acceptance of the local offer and conversion of the acceptance into purchase of the local offer.

Accordingly, various embodiments of the present disclosure generally operate to provide local offers from advertisers and other content item provides that are personalized to the interests and activities of the consumer, and in the dates and times available to interact with members of the consumer's social network, which may be more valuable advertising strategies for the consumer and the advertiser.

Various embodiments can be generally characterized as providing a personalized experience through combination of local offer, social network, and calendar event. A personalized ad, e.g., local offer, may be responsive to user's preferences and social networks. The personalized ad may be displayed for the user as an event opportunity in a suggestion calendar. The business can advertise by making the local offer available to the user through the suggestion calendar. Social networks may contain family and friends who may wish to participate with the user in a group activity. The user can use the personalized ad to organize the group activity associated with the local offer.

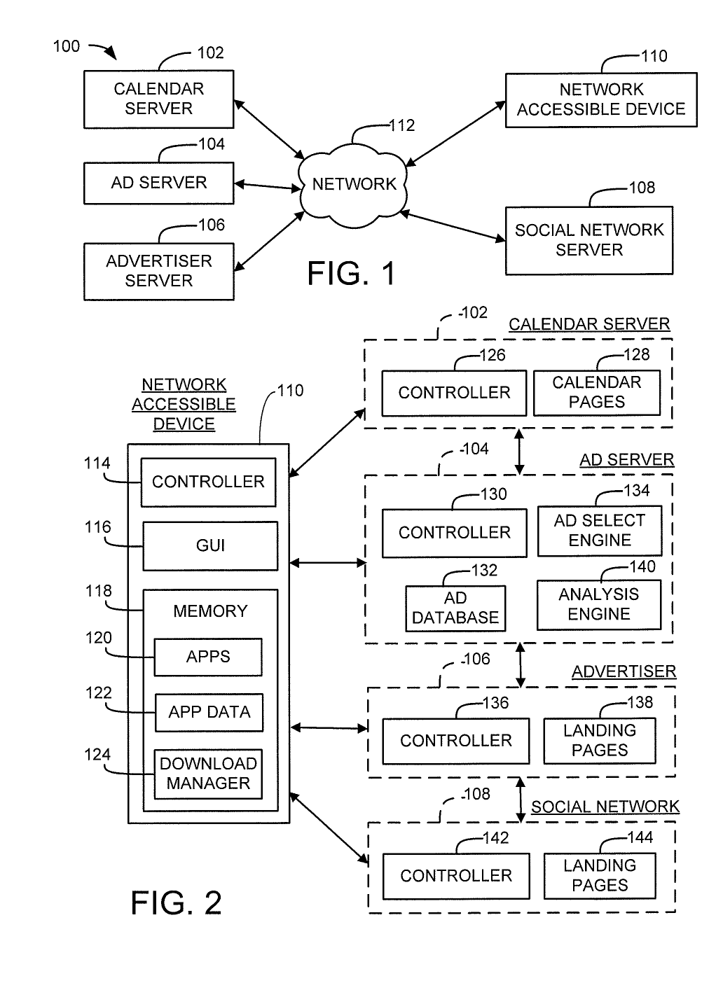

These and other features and benefits of the present disclosure can be understood beginning with a review of FIG. 1, which depicts a network-based data transfer system 100 constructed and operated in accordance with various embodiments.

For purposes of providing a concrete example, content items serviced by the system 100 will be contemplated as comprising advertisements (ads) that are displayed in suggested event slots in a suggestion calendar. It will be appreciated that this is merely for purposes of illustration and is not limiting.

The system 100 incorporates a number of active elements including a calendar server 102, an advertisement (ad) server 104, an advertiser (content item owner) server 106, a social network server 108, and at least one user network accessible device 110. The various servers and devices in FIG. 1 communicate via a network fabric 112, which may constitute one or more communication networks such as the Internet, a WAN (wide area network), a LAN (local area network), a broadband wireless network, etc.

The calendar servers 102 are contemplated as providing a suggestion calendar for interaction of the user with the advertiser and the user's social network members (e.g., family and friends). The suggestion calendar can incorporate event suggestions on calendar web pages for display on the device 110.

The calendar of personalized ads could be available to other calendar systems, such as Google Calendar, Microsoft Outlook and Apple Calendar. The calendar server 102 can be configured to integrate with a social network, such as Google+. The suggestion calendar can be configured to integrate with a network accessible calendar, such as Google Calendar. The event on the suggestion calendar can be configured to integrate with a network accessible calendar event, such as Google+ Events.

The ad server 104 services ad requests to display ads in conjunction with the calendar web pages. The advertiser server 106 can be associated with a source or owner of the goods or services associated with the ads supplied by the ad server. The social network servers 108 represent web page hosting servers or similar systems for social networks, such as Google+, Facebook, LinkedIn, adapted to transfer web pages to the device 110. The user's social network members include family and friends connected to the user through the social network servers 108.

The network accessible device 110 can take a variety of forms, such as a desktop computer, a laptop computer, a smart phone, a tablet, a gaming console, a television, or other similar device adapted to interact with the calendar server 102, the ad server 104, the advertiser 106, and the social network server 108.

It will be appreciated that other elements may be incorporated into the system 100 as desired.

FIG. 2 shows aspects of the system 100 of FIG. 1 in accordance with some embodiments. The network accessible device 110 from FIG. 1 will be contemplated to be a smart phone in FIG. 2, although this is merely for purposes of providing a concrete example and is not limiting.

The device 110 includes a controller 114, a graphical user interface (GUI) 116 and memory 118. The controller 114 may be a programmable processor that uses associated operating system programming and application software (e.g., a web browser) in the memory to interact with the network 112.

The GUI 116 may include a display monitor, keyboard, mouse, speakers, headphones, a touch screen, etc. The memory 118 may represent a hierarchical memory structure made up of various memory devices within the user device 110, including such elements as a non-volatile main memory (e.g., disc memory, solid-state drive, etc.), data transfer buffer, local processor (L1-L3) cache, etc.

The memory 118 stores various operational modules including applications (apps) 120 and application (app) data 122. A download manager 124 operates to control communications and data transfers across the network 112.

The calendar server 102 may include a controller 126 and a memory that stores a number of available calendar web pages 128. The web pages are transferred responsive to requests from the device 108.

The ad server 104 includes a controller 130, an ad database 132 in associated memory, and an ad selection engine 134. The ad selection engine 134 may be realized as a processor routine stored in the memory and executed by the controller 130, or may be a separate hardware or software module (including a remote module). The ad selection engine generally operates to transfer one or more ads from the database 132 for display on the device 110 in response to ad requests from web pages and other display items loaded onto the device.

The analysis engine 140 may be configured to access a number of different databases for different ads. The analysis engine 140 can be configured to use any information that the user, as a member of the social network, consents to share for improving personalized ads displayed, or presented, to the user for group activities with other social network members. The user may consent to share some or all of the user's interests and activities with the system 100. The user may consent to use certain aspects of the suggestion calendar system such that the user may be presented with an opportunity to consent to use of some user data so that the local offers 166 displayed for the user account for particular event types, specific events, activities with selected social network members, days, dates, times, etc. At any time, the user may withdraw consent to use of the user's data in the system 100.

The user may consent to share the user's scheduled calendar, which can be used by the analysis engine 140 to display local offers that do not conflict with events on the user's scheduled calendar. The user's scheduled calendar could be present in any network accessible calendar.

Of course, the user could consent to have events suggested that conflict with the event on the user's scheduled calendar. One reason for the user to consent to display of such a conflicting event is that a member of the user's social network might accept the event, such that the user may select the event despite the conflict with the user's scheduled calendar.

The user might not consent to sharing the user's scheduled calendar with the system 100, but the user may still consent to receive personalized ads responsive to the user's interests and activities. In this scenario, the user will decide for the user's self how to handle scheduling conflicts. The calendar server 102 can be configured to simultaneously display the suggestion calendar and the user's scheduled calendar to facilitate the user comparing the user's scheduled calendar with the suggestion calendar.

The advertiser server 106 is a type of publisher server for an entity associated with at least one of the content items (ads) in the ad server. The advertiser server 106 includes a controller 136 and a set of landing pages 138 in associated memory.

The social network server 108 is a server for the social network, which is utilized by the user and the user's family and friends, adapted to transfer web pages to the device 110. The social network server 108 includes a controller 142 and a set of social applications (apps) 144 in associated memory.

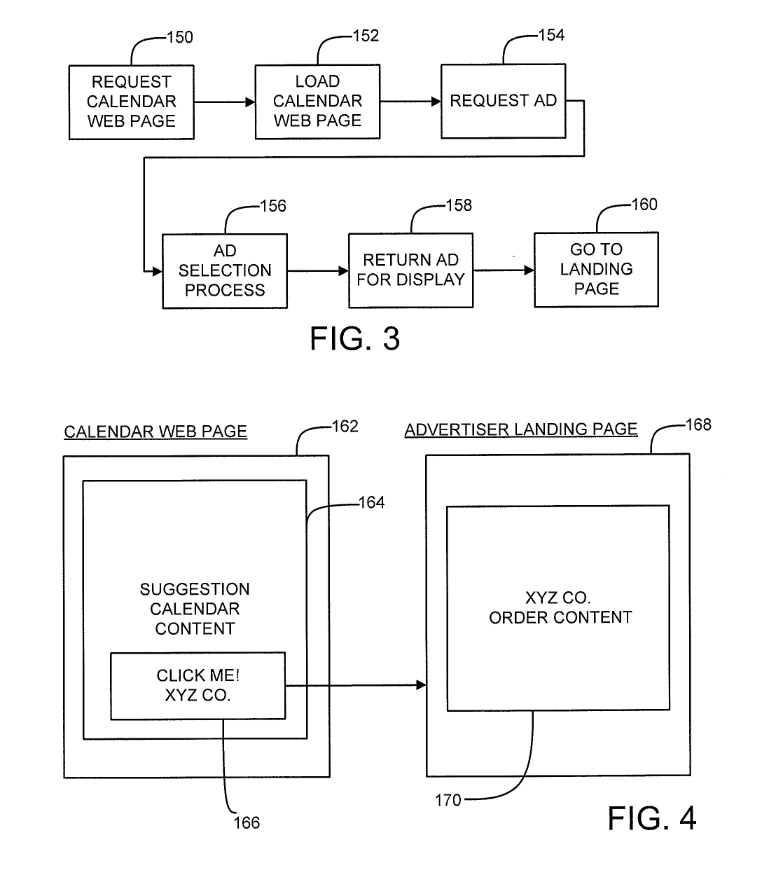

FIG. 3 illustrates a sequence of steps that can be carried out by the system of FIG. 2. At block 150, the device 110 requests a calendar web page from an associated calendar server 102. This request may be initiated in a variety of ways, such as the user activating a web browser application on the smart phone, opening a calendar application, and typing in a URL address associated with the requested page. At block 152, the device 110 generally issues a request to the calendar server 102 for the selected web page, which is accessed and returned to the user device 110 for loading on the GUI 116.

During the loading of the selected calendar web page, a request for an ad may be issued from the device 110 to the ad server 104, as shown by block 154. An ad selection process is carried out, at block 156, to select an appropriate ad (content item). Various aspects of the ad selection process will be discussed in detail below.

The selected ad is returned at block 158 for display on the user device 110. Upon user selection (a “click”) of the ad, the device 110 is connected to an associated landing page at block 160. The loading of the landing page, at block 160, is carried out in a manner similar to that discussed above in blocks 152, 154.

FIG. 4 illustrates the sequence of FIG. 3 in greater detail. An example suggestion calendar web page 162 is loaded to and displayed on the device 110. The suggestion calendar web page 162 can include a suggestion calendar content 164 and an ad content 166.

The suggestion calendar content 164 and the ad content 166 may be responsive to scheduled appointments of the user, including such items as time, location (or geo position), attendees, etc. For example, the personalized ad 166 could be responsive to the user's geo location to suggest the local offer, such as a restaurant, that does not conflict with the user's schedule and allows enough time for the user to arrive at the restaurant.

In some embodiments, the user can choose event types, such as “sports events” and “restaurants”, which interest the user. Based on the preferences of the user to various interests and activities, the suggestion calendar content 164 can display one or more personalized ads 166 on the suggestion calendar page 162 of the user. The user may accept or decline the personalized ad 166. On the other hand, the user could simply ignore and not respond to the personalized ad 166.

The user could provide feedback, or rate, the local offer embodied in the personalized ad 166. By the user electing to provide feedback, the ad server 104 can deliver the personalized ads 166 that will likely be of more usefulness to the user through incorporation of the feedback into the selection process on what personalized ads 166 to display to the user that is done by the analysis engine 140 (see FIG. 2). For example, if the user gives a high rating to an event type (such as a professional football game), a specific event (such a football game involving specific teams), etc., then the user may be more likely to receive the same, or similar, personalized ads 166 in the future. If the user gives a poor rating or ignores the local offer, then the user may be less likely to receive the same, or similar, personalized ads 166 in the future.

In other embodiments, if the user and members of the user's social network select the same, or similar, event types, the personalized ad 166 presented to the user and the user's social network members, such as family and friends, can suggest times for group activities associated the local offers of the event type.

In other embodiments, the personalized ad 166 could be responsive to the user's language or profile information, e.g., the personalized ad 166 could suggest an ethic restaurant on an ethic holiday that is likely to be of importance to the user. The personalized ad could be responsive to the user's posts on the social network, e.g., the personalized ad 166 could suggest a sports event when the user posts about the sports event type on the social network.

Returning to FIG. 4, user selection of the ad 166 results in the loading of an advertiser landing page 168 from the XYZ Co. advertiser server 106 with associated order content 170 associated with products, services or other information associated with XYZ Co.

Through the analysis engine 140 (see FIG. 2) the advertiser XYZ Co. may use information from the social network activity and profile of the user and the social network activity and profile of the family and friends of the user. For example, if the user's profile mentions fluency in Chinese, then the advertiser XYZ Co. may elect placement of the ad 166 that includes Chinese Year activities around the time of the Chinese Year.

In addition to the user providing feedback regarding suggestion calendar content by completing a survey, etc., the user can provide feedback for the suggestion calendar content by accepting (which may be interpreted to show interest) or declining (which may be interpreted to show lack of interest). The user can provide further feedback by conversion of the acceptance of the local offer 166 of the suggestion calendar content 164 into a purchase.

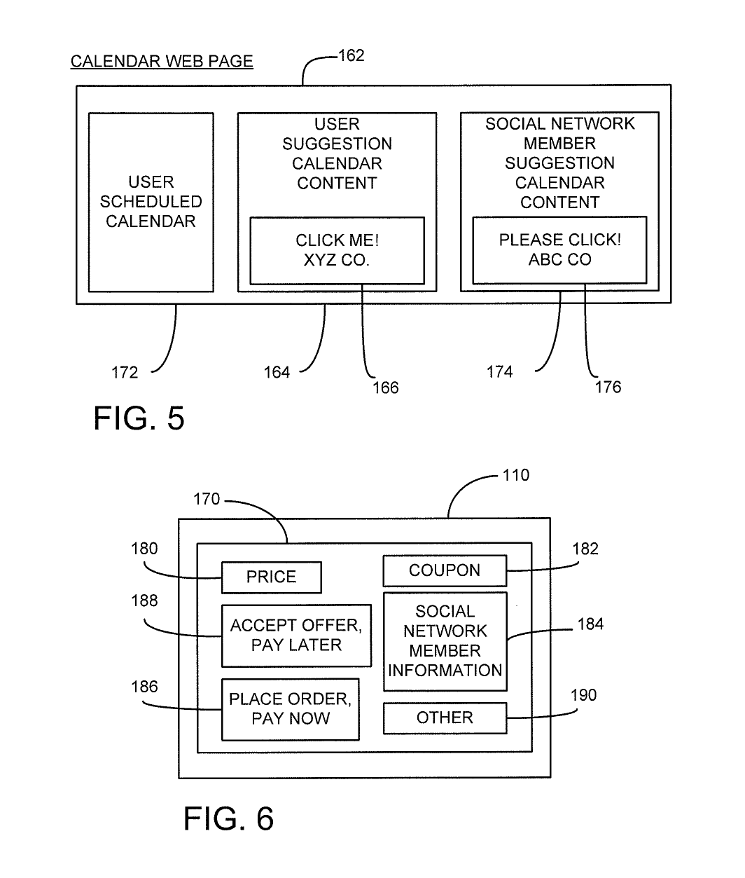

FIG. 5 illustrates in further detail the calendar web page 162, which can include the suggestion calendar content 164, the user's scheduled calendar 172, a social network member suggestion calendar content 174, and a social network member personalized ad content 176. The user's scheduled calendar 172 can be obtained from Google Calendar, a app on the device 110, or other suitable source. The user's scheduled calendar 172 displays any suitable unit of time (e.g., minutes, hours, days, weeks) for the current day, future days, or some combination, such that the user can understand time commitments already agreed to by the user.

The suggestion calendar content 164 can display the user personalized ads 166 based on the interests and activities of the user that the user consents to share with the suggestion calendar system 100. The suggestion calendar content 164 provides an option to share the user personalized ads 166 displayed for the user with members of the user's social network, which might be beneficial in the event that a particular user personalized ad 166 is not displayed as offered to some members of the user′ social network.

The social network member suggestion calendar content 174 displays information the member of the user's social network on one of the social networks, such as Google+, has consented to share with the user. The social network member personalized ad content 176 is displayed based on the interests and activities of the social network member. The social network member suggestion content 174 can display whether the social network member has accepted the local offer 176, if the social network member chooses to share this acceptance information.

The social network member suggestion calendar content 174 and social network member personalized ad content 176 could be displayed for the user even though the user might not otherwise be presented with the suggestion calendar content of the social network member, e.g., the event conflicts with the user's calendar, the user has rated the event poorly in the past, the user has not shared information to suggest interest in the suggestion calendar content, etc. Such events might be displayed for the user, because the group activity with social network members might be even more important than the event itself. The user can control can what suggestions responsive to user's social network members are presented to the user based on social network member, event type, time, date, etc.

Returning to the order content 170, FIG. 6 illustrates how the order content 170 might be displayed to the user on the device 110. It will be understood that the order content 170 can be presented to the user as an image, a form, or some combination of the two. The order content 170 could include a price 180, a coupon 182, a social network member information 184, a place order and pay now option 186, an accept offer and pay later option 188, and other features 190. Other features 190 could be added as needed.

The price 180 may be fixed per quantity, or variable based on value, day, date, time, number of social members gathering, etc. The price may be discounted for a customer with a savings coupon, repeat customer, etc.

The coupon 182 could be presented in a standard human readable language (such as English, Chinese, etc.) or in a standard machine readable language (such as UPC-A barcode, etc.). The coupon 182 might provide the user with a discount for repeat business, size of the social network group gathering, etc. The coupon 182 could be redeemed by the user presenting the coupon 182 when the user pays for the local offer in person or via the device 110.

The social network member information 184 may provide details regarding local offers that members of the user's social network have accepted or ordered. For example, the local offer accepted or ordered by members of the user's social network could be presented to the user.

With place order and pay now option 186, the user could order the local offer and pay for the local offer when placing the order. Any online payment system, such as Google Checkout, PayPal, etc. could be used to pay for the local offer.

In the accept offer and pay later option 188, the user could accept the local offer, but the user would pay for the local offer later, such as when the user attends the event, etc. Payment for the local offer would occur where the event occurs, or some other suitable location. Any online, or in person, payment system could be used to pay for the local offer.

The advertiser might understand that an acceptance of the local offer may not lead to a sale to the user, if the user does not have to pay for the local offer at the time of the accept order option 188. The advertiser could have the user redeem the coupon 182, or other feature 190, to measure how many offers were made, accepted, and purchased. As an example, the advertiser might learn that 100 local offers on a typical Tuesday at 11:45 AM will on average generate 50 acceptances and 40 of the acceptances turn into purchased local offers, 20 local offers are declined, 10 local offers are ignored, and 20 local offers are purchased when placing the order. However, on a typical Thursday at 1:15 PM 100 local offers will on average generate 25 acceptances and 15 of the acceptances turn into purchased local offers, 40 local offers are declined, 30 local offers are ignored, and 5 local offers are purchased when placing the order.

The made, accepted, and purchase local offer results could be provided to the advertiser in aggregate form. For the user that elects to share the user's individual responses to local offers directly with advertisers, the user's information can shared with the advertiser. The advertiser could reward the user with discounts, etc. for sharing the user's responses to local offers.

While the order content could be delivered to a gathering place for the user and social network members, the order content may be available at a business location of the advertiser where the user and social network members gather to share in each other's company. By providing local offers for selected times of the day or days of the week, the advertiser may drive business to the selected times of the day or days of the week, which may increase business efficiency and improve service to the user and the user's social network members that participate in the suggested event.

Some local offers may be time sensitive. For example, a restaurant may be running a special, such as serving low priced gyro sandwiches. For efficiency sake, the restaurant would prefer that consumers eat the gyro sandwiches at certain times of the day. The local offer for the gyro sandwich could offer a first price at a first time of the day, and a second price at a second time of the day. If the first price is lower than the second price, more users may buy gyros at the first time.

On the other hand, the advertiser may need to sell the gyro sandwiches in certain amount of time, for whatever reason. The advertiser could request that local offers are sent to the devices 110 in a certain geo position proximity to the business location of the advertiser at a selected time of the day or on a selected date.

The local offers sent, accepted, and ordered can be provided to the advertiser in real time, such that the advertiser can adjust the number of the local offers offered by the advertiser or features of the offer. Using the gyro sandwich as the local offer example, if the gyro sandwich is not selling well, the price in the gyro sandwich could be dropped, the preparation of gyro sandwiches could be reduced, etc.

The number of local offers provided by each advertiser can be predetermined or changed depending on acceptance rate, order rate, etc. The number of local offers accepted as orders by each advertiser can be measured. The number of local offers converted into sales, etc. can be measured, also. The information regarding the local offers can be provided to the advertiser in real time so that the business may prepare for the consumers. Further information could be provided to the business, such as reservation times, how far away the consumer geo position is from the business, etc. Such information can be provided to the user in aggregate, or the user may consent to provide the user's individual information to the advertiser. Again, the advertiser may provide the user with incentives for sharing the user's individual information with the advertiser.

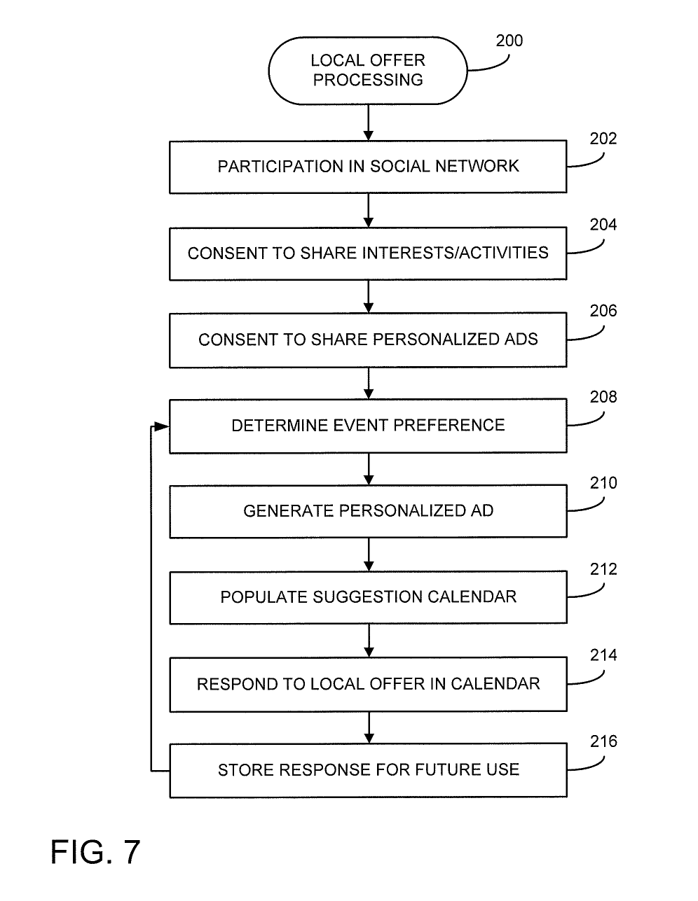

FIG. 7 sets forth a LOCAL OFFER PROCESSING routine 200 generally illustrative of steps that may be carried out in accordance with the foregoing discussion. At step 202, there is participation by the user and the user's family and friends in a social network, such as Google+.

At step 204, the user consents to share the user's interests and activities with the personalized ad system 100, such that the user can receive personalized ads from the advertiser responsive to the user's interests and activities.

At step 206, the user consents to share the personalized ads (or other content items) with the members of the user's social network, such that members of the user's social network will have the opportunity to participate in group activities related to the personalized communications displayed for the user.

At step 208, determine a preference for an event type for each of a plurality of social network users. For example, an analysis engine, such as analysis engine 140 in FIG. 2, can analyze the interests and activities of the user and the members of the user's social network in order to provide suggested events that may lead to a group activity involving the user and the user's social network.

At step 210, generate a personalized ad associated with the preference at step 204. The personalized ad includes a local offer from an advertiser, such as a business.

At step 212, populate a suggestion calendar with the personalized ad. The suggestion calendar is accessible to each of the plurality of social network users.

At step 214, each of the plurality of social network users can have a response to the local offer of ignore, accept, purchase, rate, etc.

At step 216, the user's response to the local offer can be stored by the system 100 for future use by the analysis engine, such that the personalized ads displayed for the user will be responsive to the user's response to the local offer.

It will be understood that the steps of LOCAL OFFER PROCESSING routine 200 could occur in a variety of different sequences and any of the steps may be optional. In addition, other steps are possible within the spirit of the disclosure.

In situations in which the systems and/or methods discussed herein collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

It is to be understood that even though numerous characteristics and advantages of various embodiments of the present disclosure have been set forth in the foregoing description, together with details of the structure and function of various embodiments, this detailed description is illustrative only, and changes may be made in detail, especially in matters of structure and arrangements of parts within the principles of the present disclosure to the full extent indicated by the broad general meaning of the terms in which the appended claims are expressed.

1. A computer implemented method comprising:
determining that each user of a plurality of social network users connected to one another in a social network has indicated a preference for a particular event type;
generating, based at least in part on a geographic location associated with one or more of the plurality of social network users, a personalized content item associated with the particular event type, the personalized content item including a local offer related to the particular event type from a business associated with the geographic location;
populating a suggestion calendar with the personalized content item;
providing, in the social network, the suggestion calendar to each of the plurality of social network users;
receiving an acceptance of the local offer from two or more of the plurality of social network users; and
notifying the business of the acceptance from the two or more social network users.

2. The method of claim 1, in which the preference is responsive to the geo position of at least one of the plurality of social network users.

3. The method of claim 1, in which the preference is responsive to a language of at least one of the plurality of social network users.

4. The method of claim 1, in which the preference is responsive to a profile feature of at least one of the plurality of social network users.

5. The method of claim 1, in which the preference is responsive to a social network posting of at least one of the plurality of social network users.

6. The method of claim 1, in which the preference is responsive to at least one of the plurality of social network users ignoring another previously presented personalized content item.

7. The method claim 1, in which the preference is responsive to at least one of the plurality of social network users providing negative feedback to another previously presented personalized content item.

8. The method claim 1, in which the preference is responsive to at least one of the plurality of social network users providing positive feedback to another previously presented personalized content item.

9. The method claim 1, in which the preference is responsive to at least one of the plurality of social network users accepting another previously presented personalized content item.

10. The method claim 1, in which the preference is responsive to at least one of the plurality of social network users purchasing a product or service responsive to another previously presented personalized content item.

11-15. (canceled)

16. An apparatus comprising:
a processor; and
a memory which stores programming for the processor adapted to, responsive to receipt of a request from a network accessible device for an advertisement (ad) to be displayed in conjunction with an application executing on the network accessible device, perform steps of:
determining that each user of a plurality of social network users connected to one another in a social network has indicated a preference for a particular event type;
generating, based at least in part on a geographic location associated with one or more of the plurality of social network users, a personalized ad associated with the particular event type, the personalized ad including a local offer related to the particular event type from a business associated with the geographic location;
populating a suggestion calendar with the personalized ad;
providing, in the social network, the suggestion calendar to each of the plurality of social network users;
receiving an acceptance of the local offer from two or more of the plurality of social network users; and
notifying the business of the acceptance from the two or more social network users.

17. The apparatus of claim 16, in which the preference is responsive to the geo position of at least one of the plurality of social network users.

18. The apparatus of claim 16 in which the preference is responsive to a language of at least one of the plurality of social network users.

19. The apparatus of claim 16 in which the preference is responsive to a profile feature of at least one of the plurality of social network users.

20. The apparatus of claim 16 in which the preference is responsive to a social network posting of at least one of the plurality of social network users.
